(19) United States
(12) Patent Application Publication
(10) Pub. No.: US 2003/0172283 A1
(43) Pub. Date: Sep. 11, 2003

(54) Biometric characteristic-enabled remote control device

(76) Inventor: Sean M. O'Hara, Lebanon, OR (US)

Correspondence Address: HEWLETT-PACKARD COMPANY, Intellectual Property Administration, P.O. Box 272400, Fort Collins, CO, 80527-2400, US

(21) Appl. No.: 10/046,361

(22) Filed: Oct. 25, 2001

(51) Int. Cl. H04L 9/00

(52) U.S. Cl. 713/186

(57) ABSTRACT

A wireless remote control device for use with television receivers, satellite down converters and similar devices, uses biometric characteristics of a user to determine the functionality to be imbued to the remote control device. A biometric scanner, such as a capacitive fingerprint scanner, coupled to a processor, compares scanned characteristics to stored characteristics to determine the identity of the user. By using biometric characteristics to identify the user, passwords, PIN numbers, keys and other indicia used to establish authorization of a user enable the authorized user to access programming and subject matter unsuitable for or unintended for unauthorized users.

### FIELD OF THE INVENTION

This invention relates to hand-held remote control devices, such as those commonly used to control television receivers, video cassette recorders, satellite and cable television signal decoder boxes and the like. More particularly, this invention relates to a method and apparatus for securing the usage of remote control devices and in turn, securing the usage of the systems that the remote control devices are used with.

### BACKGROUND OF THE INVENTION

Hand-held infrared and radio frequency remote control devices are commonly used to remotely control appliances such as television receivers, compact disc players, cable and satellite television decoder boxes. These remote controls enable the user to easily and conveniently control a device such as a television tuner from a chair or other part of a room where the device is located without having to physically interact with it. Indeed, almost all televisions are now sold with a remote control by which the television can be remotely turned on and off, channel reception enabled or disabled and even color levels, tint, contrast and brightness adjusted using the remote control. Compact disc players, video cassette recorders and cable and satellite television signal decoder boxes also typically sold with infrared remote controllers.

Hand-held remote controls typically use an infrared transmitter to generate an infrared signal that it received and recognized by the device that the remote control device is used to operate. The signaling used between a remote and its corresponding slave device by various appliance manufactures is well known and universal remote control devices which can used with virtually any manufacturer's appliance include the ability to generate a plethora of different signals enabling them to be used with devices made by many different manufacturers.

A limitation of prior art infrared remote control devices (separate and apart from their tendency to become lost or misplaced) is that there is presently no convenient way to limit the operation of the appliances they are used with, on a user-by-user basis. For example, a child's access to certain television channels can be locked out by a parent by a numeric access code, however, the locked out channel can only be viewed when the correct access code is provided. By way of another example, there is at present no way to inhibit television picture adjustments when the remote control device is used by one person but disabled when the remote control is used by another person. A mechanism by which the functionality of a remote control can be conveniently limited to certain persons using it would be an improvement over existing remote control devices, which rely upon numeric lock-out or access codes to inhibit certain functions of a controlled device.

### SUMMARY OF THE INVENTION

A method of controlling functionality of a device and an apparatus having functionality control includes an input device that receives an input command from a user. A biometric scanner is adapted to obtain a first biometric characteristic of a user of the input device device and a memory stores representations of a biometric characteristic of at least one individual. A processor is operatively coupled to the biometric scanner, the memory, and the input device, such that the processor reads signals from the input device, reads signals from the scanner, and compares biometric characteristics as measured by the scanner to representations of biometric characteristics stored in the memory. A transmitter is coupled to the processor and transmits predetermined signals therefrom upon the identification of a scanned biometric characteristic to a stored representation of a biometric characteristic.

### BRIEF DESCRIPTION OF THE DRAWINGS

FIG. 1 shows an isometric view of a remote control device comprised of a remote control device employing a biometric scanner.

FIG. 2 shows a block diagram of the functional elements of the remote control device shown in FIG. 1.

FIG. 3 shows a block diagram of the functional elements of a slave to (controlled by) the remote control device shown in FIGS. 1 and 2.

FIG. 4 shows a simplified block diagram of process steps employed in a biometric characteristic-enabled remote control.

### DETAILED DESCRIPTION OF THE PREFERRED EMBODIMENT

A remote control device limits its functionality according to biometric-characteristic of the device's user. A remote control device is equipped with a biometric scanner that is coupled to a processor within the remote control device and which scans a user's biometric characteristic. The processor within the remote control device compares the scanned or measured biometric characteristic of the user against stored characteristics of authorized users of the remote control device to determine who the user is, and the functionality of the device that the user is entitled to. When the processor software determines that a sensed biometric characteristic matches an authorized user, the functionality of the remote control device is enabled or disabled (as appropriate) by the remote control's onboard computer accordingly. The remote control's onboard computer and software within the remote control thereafter enables or disables the transmission of signals from the remote control device by which the controlled slave device (e.g. television receiver; cable television receiver) can be operated with the functionality to which the user is entitled. In one embodiment of the invention, a fingerprint scanner coupled to a computer within the remote control device provides a secure, biometric characteristic-enabled remote control device.

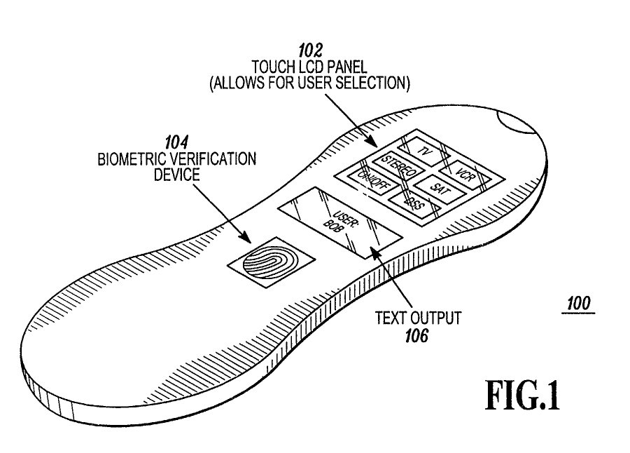

FIG. 1 shows an isometric drawing of a remote control 100 the functionality of which is enabled using biometric characteristics (such as a finger print) of the device's user. Inasmuch as the device's capabilities are controlled by biometric characteristics, the device 100 is considered to be a biometric characteristic-enabled, hand-held remote control device 100 (“device”). The device 100 can be used for selectively providing different levels of control and access to appliances such as a television receiver, video cassette recorder, compact disc player, cable television decoder or a satellite television receiver or the like according to the identity of the person using it. Because a biometric characteristic uniquely identifies the user, there is no need for the user to remember access codes and the like in order to define the functions of the slave device it controls.

The device 100 includes an input keypad 102, comprised of a touch-sensitive LCD panel or a matrix of push-buttons, which allows a device 100 user to select various features of a controlled appliance device (not shown). The device 100 also includes a biometric scanner 104 which enables the device 100 user to be uniquely identified by comparing the scanned characteristics of the device 100 user to stored characteristics of authorized users. As set forth below, the remote control device 100 relies upon biometric characteristics of the user holding the device and that can be sensed by the biometric scanner 104 to grant or deny access to certain functions and features of a controlled slave device so as to obviate the need for each user to remember any sort of password or code. In one embodiment, output screen 106 provides for the display of output messages to the person holding the device 100. Informative messages to the device 100 user would include, but not limited to, keypad input echoes (displaying on the screen the entered keystrokes) prompts to the user to submit a thumb or other finger for scanning, advisories that the scan was not read or did not match stored characteristics, the current time of day, the present channel being displayed and so forth.

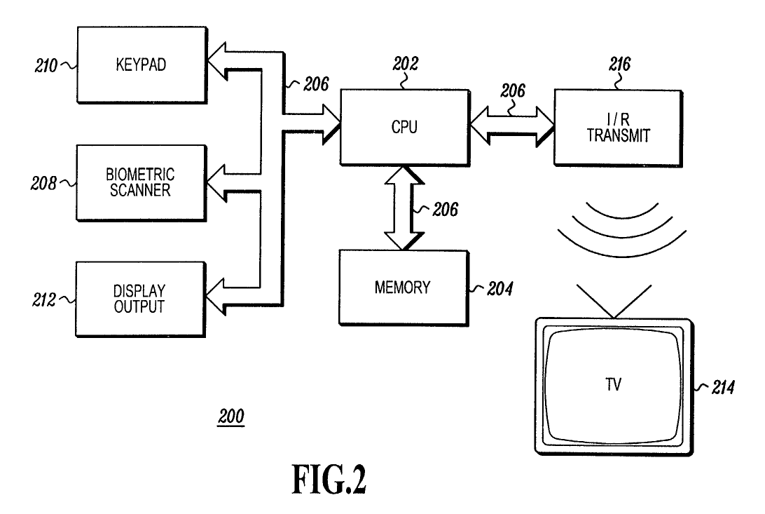

By controlling the functionality of the device 100 using a biometric characteristic such as a finger-print, voice scan, or retinal pattern there is no need for the device user to remember code words or passwords to enable or disable functionality of the device, 100 or an appliance that it controls. The biometric characteristics of users can instead be used to uniquely enable or disable features and functions of either the device 100 or its slave. FIG. 2 shows a block diagram of the functional components of the biometric characteristic-enabled remote control device 100 depicted in FIG. 1. The device 200 shown in FIG. 2 is comprised of a central processor (CPU 202 (typically a microcontroller, microprocessor, digital signal processor and equivalents thereof) coupled to a memory array 204 (e.g., semiconductor: read only memory or ROM; random access memory or RAM; electrically programmable read only memory or EPROM; electrically erasable programmable read only memory EEPROM; and equivalents thereof) via a control bus 206.

The CPU 202 reads program instructions stored in memory 204 and executes the program instructions, thereby giving the remote control device it's functionality, which includes the ability to read input commands from a keypad 210 that is coupled to the CPU via the control bus 206. Input commands at the keypad 210 which are read by the CPU 202 can also be displayed by the CPU on an output device (echoed back to the user) such as an LCD screen 212.

The device depicted in FIG. 1 and shown in block diagram in FIG. 2 includes a biometric scanner 208, which is also coupled to the CPU 202 via the control bus 206. In a preferred embodiment, the biometric characteristic scanner (also sometimes referred to as a “sensor”) 106 is a capacitive fingerprint sensor available from at least Veridicom, Inc. of Santa Clara, Calif. the specifications of which are available at the time of filing this application at www.veridicom.com. The terminology “biometric scanner” is used herein to refer to devices that can electronically read or “scan” a particular biological (bio-) measurable (metric) characteristic such as a finger print pattern, retinal pattern, or a “voice print” pattern. A finger print, retina and the audio-frequency components of a voice are all biometric characteristics that can be used to identify an individual.

At the time of filing this application, biometric scanners (or sensors) are also available from Ethentica, Inc. of Aliso, Viejo, Calif. Ethentica's product specifications and other data about tactile fingerprint sensors are available on the Ethentica website at www.ethentica.com. Still other types of biometric sensors 106 would include retinal scanners and voice recognition devices, which, among other things, can identify the distinctive frequency components and waveforms of an individual'spoken voice.

In the preferred embodiment, a fingerprint sensor, (such as the Veridicom model FPS110 sensor) provides a relatively high resolution “image” of the peaks and valleys of an individual's fingerprint using a matrix of parallel plate capacitors, one plate of each of which is formed by a users' finger tip surface and the other one of which is one of 90,000 or more “plates” formed on the finger print sensor. When an individual places his finger on the sensor, the finger acts as one of the plates of a dual plate capacitor. The other plate is formed on the silicon chip containing an array of capacitor plates.

According to data provided by Veridicom on its web site as of the filing date of this application, the Veridicom devices are capable of sensing finger print characteristics at a relatively high resolution of 500 dots per inch. The Veridicom module can create a raster-scanned image of the ridges and valleys of the finger pressed against the chip. The raster scan image data is converted by the Veridicom device to a video signal that is represented by 8 bit digital words, which can be read by the central processing unit 202 via the address and control bus 206. The 8 bit words representing a raster can be even further processed, such as by computing a one-or-more byte checksum, to even further compress or truncate the volume of data required to represent a biometric characteristic.

In order to enable unlimited access to the functionality of either the device 200 or a slave that it controls, the identity of the user is determined by comparing the raster scan read from the scanner 208 to a library of previously-read raster scans stored in memory 204. During an initialization process, the thumb print of a super user, who is to have unlimited access to slave device functionality, is read from the scanner 208 by the CPU 202 and stored in memory 204 as an array of data. Th scan of a finger of a super user can be initiated by way of a keystroke or series of keystrokes at the keypad 210 followed by the submission of the super user's finger print for analysis. Such a representative scan of an authorized user can thereafter be compared against new scans to determine if the authorized user subsequently places his finger on the scanner 208.

In the preferred embodiment, the process of veriifing an individual's identity and authorizing that person to have unlimited access to the functionality of the slave device is performed by the software within the CPU 202, which compares data from the sensor 208 that represents a scanned biometric characteristic, to either data or data templates stored for various individuals in memory 105. (The term “data templates” refers to compressed, modeled, sampled or other truncation of raw scanner data, which can be stored in smaller amounts of memory than would be required to store the raw data of a scan, yet reliably identify an individual notwithstanding its truncation. For purposes of this disclosure and in particular, claim construction, “data” and “data templates” and truncated data representing a biometric characteristic are all considered to be equivalents of each other.)

If after comparing the data from the sensor 208 to stored data or data templates of biometric characteristics of authorized individuals, the software within the processor 202 rejects the access attempt, the individual identified by the data from the sensor 208 is denied permission to have access to certain functions of the slave device. If the biometric data from the sensor 208 substantially matches data of an authorized individual, that person is provided with the ability to send signals to a controlled slave device 214 from an infrared transmitter 216. If the slave device 214 is a television receiver or a satellite television signal down-converter, the device 200 can inhibit the selection of certain channels by any individual other than the super users identified by his or her finger prints. The template of more than one super user can certainly be stored within memory 204. The identification of a finger print with a previously stored template can be considered to be a unique identification of the device 200 user.

While the preferred embodiment of the invention is to grant or deny functionality of the device 200 based upon a biometric characteristic of the user, an alternative embodiment of the invention controls access to an appliance such as a television receiver, cable television decoder or a satellite television signal decoder by sensing a biometric characteristic by the appliance.

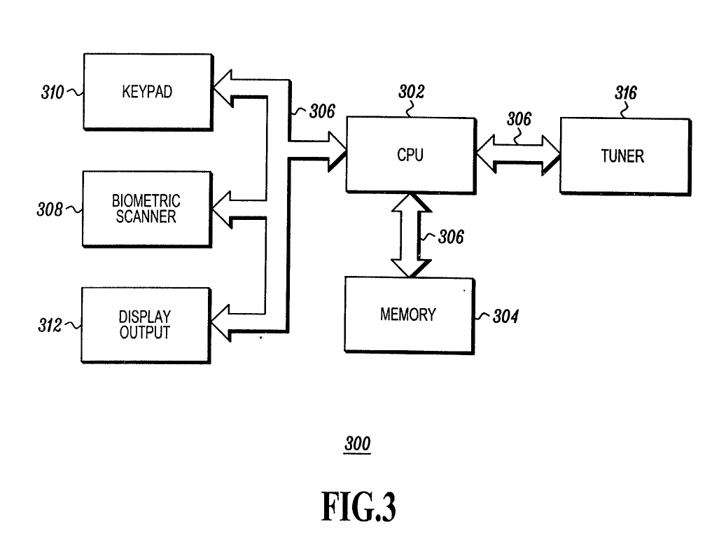

FIG. 3 shows a simplified block diagram of part of a slave device, e.g., a television, receiver or a satellite television signal decoder (sometimes referred to as a decoder box) that is controllable by way of a remote control device shown in FIGS. 1 and 2. A CPU 302 reads input commands for the slave device from an input keypad 310. The input commands from the keypad 310 are read by the CPU, which can also echo the input commands to the display 312.

Like the aforementioned remote control device (FIG. 1 and FIG. 2), a biometric scanner 308 that is coupled to the CPU 302 via a control bus 306 reads a biometric characteristic from a user. The CPU 302 reads the biometric characteristic via the scanner 308 and compares the scanned data with templates of super users that are stored in memory 304. When a biometric characteristic scanned by the scanner 308 substantially matches the characteristics of previously identified super users, the biometric characteristics of which are stored in memory 304, the CPU can enable (or inhibit) functionality of the slave device's tuner 316, such as by inhibiting the display of certain channels or program material, via commands carried to the tuner 316 on the control bus 306.

With respect to both the slave device 300 and the controller 200, in some instances, a stored representation of a biometric characteristic might not identically match a contemporaneously obtained sample. By way of example, an injury might prelude an exact match of a finger print image from a scanner to a stored sample thereof. In such instances, software that measures the correspondence between a contemporaneous sample and a stored sample must evaluate the degree, or amount by which the two images differ. One method by which images could be compared is a pixel-by-pixel comparison. The acceptable number or level of differences between a stored representation of a biometric characteristic and a characteristic just read is a design choice. In some instances where maximum security is required, a 100% correspondence might be necessary. In other instances, a reasonable certainty of identification might be considered to be tolerable. Methods to compare a scanned biometric characteristic to a stored or archived characteristic are known in the art.

In the embodiment shown in FIGS. 1 and 2, when the biometric characteristic-enabled remote control device 200 makes the determination that a user is authorized (by performing, a comparison set forth above) the processor 202 enables the infrared transmitter 216 to generate signals that control a slave device and enable the slave device to perform functions not available to remote control device users in general. With respect to a biometric characteristic-enabled slave device shown in FIG. 3, recognition of certain biometric characteristics by the scanner 308 and the CPU 302 software enable the slave device to perform functions not otherwise enabled.

By using a biometric characteristic to identify users who should have unlimited access and control, prior art security techniques of access codes and passwords, which are frequently forgotten or lost, can be eliminated.

In another embodiment of the invention the device 200 acts only as a biometric characteristic collector and forwarder. Data from the scanner 208 is read by the CPU 202 and sent to the controlled slave device (not shown) for analysis. The data transmitted from the device 200 to the slave can include, but is not limited to: raw scan data from the scanner 208; data representing the raster scan of the image from the scanner 208; truncated or otherwise compressed forms of either the raw data or raster data. Upon receipt of the data by the slave device, it performs the process of validating a user by comparing scanned characteristics to stored characteristics. A comparison of scanned characteristics to stored characteristics can be performed in the base station such that a determination of the user's identity is assured.

While the preferred embodiment contemplate using an infrared transmitter in the device 200 and an infrared receiver in a controlled slave, alternate embodiments would include using the Bluetooth communications protocol, the details of which are available from the “Bluetooth” website, www.Bluetooth.com. The Bluetooth™ communications protocol is a wireless communications device connection protocol that enables various wireless communications devices (computers, phones and other devices) to communicate with each other using globally available radio frequencies ensuring worldwide compatibility. The Bluetooth technology is a product of a joint effort between 3Com, Erickson, Intel, IBM, Lucent, Microsoft, Motorola, Nokia and Toshiba. Several hundred other manufacturers are expected to adopt or comply with the Bluetooth communications protocol, the details of which are available on the Bluetooth.com website.

Bluetooth essentially provides a short range standardized communications protocol for use with wireless (i.e. radio frequency) devices. By using the Bluetooth communications protocol, signals from the modulator/transmitter 108 can be transferred to a security or access control device the function of which is to control access to assets such as bank accounts, computer files, or physical access to real property assets. In addition to the Bluetooth protocol, other wireless, radio frequency signals could be used to wirelessly transfer data between the security device 102 and the base station 103.

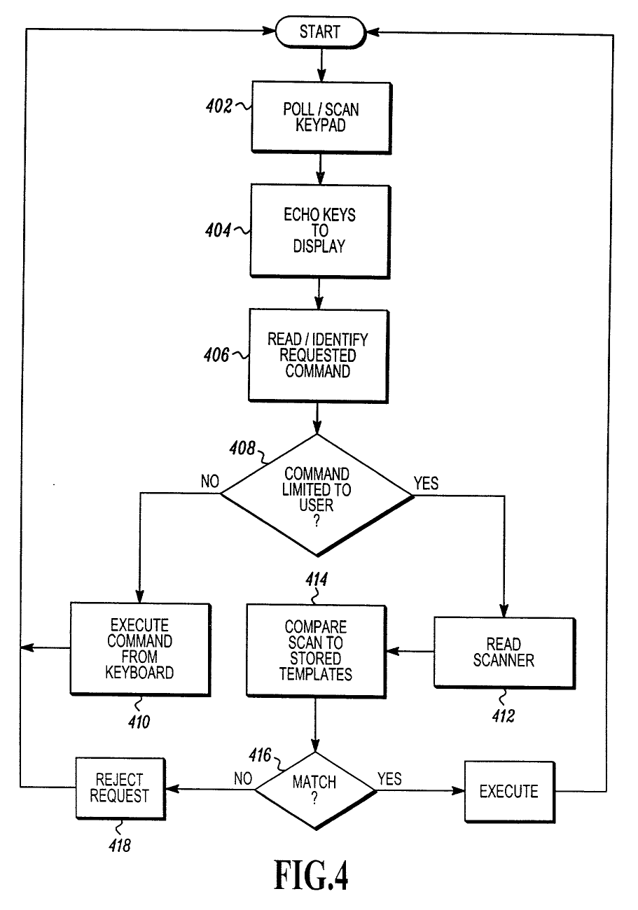

FIG. 4 shows a simplified block diagram of process steps 400 employed in a biometric characteristic-enabled remote control 200 as well as a slave device 300 equipped with a biometric scanner 208, 308 to identify authorized users. With respect to the devices shown in both FIG. 2 and FIG. 3,the first step 402 of the process 400 requires that the input devices 210, 310 be scanned or read by the CPUs 202, 302 to determine thc command (button or keys depressed) that the device user is attempting to implement. Inasmuch as the purpose of the biometric identification is to determine whether the user is authorized to access a functionality or to implement some command that should not be made by all users, the command that the user wants to execute determines whether a biometric scan and identification is even necessary.

Depending upon whether an output display is available, in step 404, the input key or button depressed by thee user generates a message that is sent to a display device 212, 312 so as to provide a feedback for the user on the command that the device 200, 300 recognized.

Inasmuch as the controller 200 can effectuate the performance of several different operations or functions in a slave device, the particular command that the user wants to implement must be identified so that the CPU can cause an appropriate signal to be transmitted from the IR transmitter 216. Those skilled in the art will recognize that different functions of the slave are implemented by way of different signals sent from the controller 200. In step 406, the key or button that was actuated by a user, is correlated to a particular functionality of the controlled appliance (e.g. change a channel or increase audio output level or adjust television picture characteristics). In step 408, the command that was identified in step 406 is tested to see if it is a command that is limited to certain individuals. By way of example, a command at the input keypad 210 to increase the output audio volume, is not normally a function that is limited to only certain individuals. In contrast, many families might want to limit access to pay-per-view television channels, and access to certain types of mature subject matter should to an adult.

In step 408, a test of the command that was identified in step 406 is performed. If the command is not limited, i.e., any user should be able to implement it, the input command is executed in step 410 with program control returning to the polling or scanning of the keypad 402. In step 408, if the input command is determined to be limited to certain individuals, the biometric scanner is read in step 412 followed by a comparison of the scanned characteristic to stored templates in step 414.

In testing a scanned characteristic to a stored template in step 416, a determination is made if a match between the two samples exists. If a match between the scanned characteristic and a biometric characteristic template is established in step 416, the command is executed in step 420 with program control returned to step 402. If no match between the scanned characteristic and a library of characteristics, the command is rejected, possibly causing the display of an appropriate error message to the user on the output device 212, 312.

In the preferred embodiment, a fingerprint scan is achieved using the devices disclosed above. Other biometric scanning embodiments would require the scanning of retinal patterns or images. Still other embodiments would employ voice recognition using Fourier analysis of voice samples, the purpose or purposes of which is to render a reasonably unique numeric representation of an individual.

Step 414 presumes that a database of authorized individuals was created by reading biometric characteristics and storing them in an appropriate memory 204, 304. By way of example, individuals to whom access to a particular functionality of a slave device is to be granted, might have their fingerprints scanned for archival purposes and stored in a database for subsequent retrieval.

In step 416, the characteristics of the scanned fingerprint as compared to those in the database are tested for correspondence and if no correspondence is found, the program control loops back to keypad reading step 402 or to an error message in step 418 which might be used to inform a user that his request for access or authorize was denied.

For purposes of claim construction, a biometric scan by a biometric scanner includes a finger print, voice print or retinal image. Instead of using infrared signals, high-frequency audio and radio frequency signals could be used as well.

By use of the foregoing method and apparatus, readily available biometric sensors can be used to reliably identify a person or persons to whom programming and functionality should be limited or unlimited. By using biometric characteristics that are unique to an individual, lost or forgotten passwords, PIN numbers, and keys no longer restrict access to resources, simplifying security and access to various features.

What is claimed is:

1. A biometric characteristic enabled remote control device comprised of:
an input device that receives an input command from a user;
a biometric scanner adapted to obtain a first biometric characteristic of a user of said device;
a memory storing representations of a biometric characteristic of at least one individual;
a processor operatively coupled to: said biometric scanner; said memory; and said input device, said processor reading signals from said input device and reading signals from scanner and comparing biometric characteristics as measured by said scanner to representations of biometric characteristics stored in memory; and
a transmitter coupled to said processor and which transmits predetermined signals therefrom upon the identification of a scanned biometric characteristic to a stored representation of a biometric characteristic.

2. The device of claim 1 wherein said biometric scanner is a capacitive finger print scanner.

3. The device of claim 1 wherein said biometric scanner is an optical retina scanner.

4. The device of claim 1 wherein said biometric scanner is a voice print scanner.

5. The device of claim 1 wherein said transmitter is a Bluetooth-compliant transmitter.

6. The device of claim 1 wherein said transmitter is an infrared transmitter. 10018528

7. A biometric characteristic enabled slave device comprised of:
an input device that receives an input command from a user;
a biometric scanner adapted to obtain a first biometric characteristic of a user of said device;
a memory storing representations of a biometric characteristic of at least one individual;
a processor operatively coupled to: said biometric scanner said memory; and said input device, said processor reading signals from said input device and reading signals from scanner and comparing biometric characteristics as measured by said scanner to representations of biometric characteristics stored in memory; and
a tuner, operatively coupled to and receiving signals from said processor, said signals from said processor enabling or inhibiting functionality of said tuner.

8. The device of claim 7 wherein said biometric scanner is a capacitive finger print scanner.

9. The device of claim 7 wherein said biometric scanner is a retina scanner.

10. The device of claim 7 wherein said biometric scanner is a voice print scanner.

11. The device of claim 7 wherein said transmitter is a Bluetooth-compliant transmitter.

12. The device of claim 7 wherein said transmitter is an infrared transmitter.

13. A method of controlling functionality of a slave appliance from a remote control device comprised of:
obtaining a first biometric characteristic of an individual at said remote control device;
generating a numeric representation of said first biometric characteristic within said remote control device;
comparing said first biometric characteristic to the representation of a second biometric characteristic within said remote control device to determine within said remote control device if said first characteristic is substantially the same as said second characteristic; and
if said first and second characteristics are substantially the same, transmitting a message to said slave appliance from said remote control device.

14. The method of claim 13 wherein said step of transmitting a message includes the step of transmitting a message using infrared frequency signals.

15. The method of claim 13 wherein said step of transmitting a message includes the step of transmitting a message using radio frequency signals.

16. The method of claim 13 wherein said step of obtaining a first biometric characteristic is comprised of the step of optically scanning a finger print.

17. The method of claim 13 wherein said step of obtaining a first biometric characteristic is comprised of the step of capacitively scanning a finger print.
